(19) United States
(12) Patent Application Publication
(10) Pub. No.: US 2019/0318746 A1
(43) Pub. Date: Oct. 17, 2019

(54) SPEECH RECOGNITION DEVICE AND SPEECH RECOGNITION METHOD

(71) Applicant: SUBARU CORPORATION, Tokyo (JP)

(72) Inventor: Tatsuo KANO, Tokyo (JP)

(73) Assignee: SUBARU CORPORATION, Tokyo (JP)

(21) Appl. No.: 16/372,761

(22) Filed: Apr. 2, 2019

(30) Foreign Application Priority Data
Apr. 11, 2018 (JP) 2018-076314

(51) Int. Cl. G10L 17/22; G10L 25/51; G10L 17/00; G06K 9/00; G06F 16/25; G06F 16/23

(52) U.S. Cl. CPC G10L 17/22; G10L 25/51; G06F 16/2379; G06K 9/00791; G06F 16/252; G10L 17/005

(57) ABSTRACT

A speech recognition device includes: a voice receiver; an age estimator; an operation discriminator; and an operation permission determiner. The voice receiver receives a speech voice of a speaker. The age estimator estimates an age of the speaker. The operation discriminator discriminates an operation intended by the speaker on a basis of the speech voice. The operation permission determiner determines a permission or a prohibition of the operation on a basis of the estimated age of the speaker.

### CROSS-REFERENCE TO RELATED APPLICATIONS

The present application claims priority from Japanese Patent Application No. 2018-076314 filed on Apr. 11, 2018, the entire contents of which are hereby incorporated by reference.

### BACKGROUND

The disclosure relates to a speech recognition device and a speech recognition method.

Conventionally, for instance, Japanese Unexamined Patent Application Publication (JP-A) No. 2007-233744 relates to a driver-assistance device that performs a notification process at a timing adapted to a driver, and discloses that age information and driving history information are referred to in the case of warning about collision, and the warning is output at a timing according to judgment speed, response speed, accuracy of operation performed by the driver.

### SUMMARY

An aspect of the disclosure provides a speech recognition device including: a voice receiver configured to receive a speech voice of a speaker; an age estimator configured to estimate an age of the speaker; an operation discriminator configured to discriminate an operation intended by the speaker on a basis of the speech voice; and an operation permission determiner configured to determine a permission or a prohibition of the operation on a basis of the estimated age of the speaker.

Another aspect of the disclosure provides a speech recognition method including: receiving a speech voice of a speaker; estimating an age of the speaker; discriminating an operation intended by the speaker on a basis of the speech voice: and determining a permission or a prohibition of the operation on a basis of the estimated age of the speaker.

### BRIEF DESCRIPTION OF THE DRAWINGS

FIG. 1 is a schematic diagram illustrating a configuration of a system according to an embodiment of the disclosure;

FIG. 2 is a flowchart illustrating a process performed in a control device;

FIG. 3 is a schematic diagram illustrating an instance of an age category database;

FIG. 4 is a schematic diagram illustrating an instance of a speech recognition dictionary; and

FIG. 5 is a schematic diagram illustrating data stored in an operation permission database.

### DETAILED DESCRIPTION

In the following, some preferred but non-limiting embodiments of the technology are described in detail with reference to the accompanying drawings. Note that sizes, materials, specific values, and any other factors illustrated in respective embodiments are illustrative for easier understanding of the technology, and are not intended to limit the scope of the technology unless otherwise specifically stated. Further, elements in the following example embodiments which are not recited in a most-generic independent claim of the technology are optional and may be provided on an as-needed basis. Throughout the present specification and the drawings, elements having substantially the same function and configuration are denoted with the same reference numerals to avoid any redundant description. Further, elements that are not directly related to the technology are unillustrated in the drawings. The drawings are schematic and are not intended to be drawn to scale.

In recent years, speech recognition technologies of recognizing speeches of human have been used in smartphones, PCs, and the like. On the other hand, when operation is unlimitedly received by a vehicle such as an automobile, it is detrimental to vehicle control in the case where it is assumed that vehicle is controlled on the basis of speeches of a driver. For instance, in the case where a young occupant who cannot get a driver's license because of his/her age instructs the vehicle to start or stop driving by voice, the vehicle may work inappropriately on the basis of the instruction from the occupant other than a driver if the vehicle actually starts or stops driving in accordance with the voice.

According to the technology disclosed in JP-A No. 2007-233744, warning is output at a timing corresponding to accuracy of operation by referring to the age information or the like. However, according to the technology disclosed in JP-A No. 2007-233744, it is not assumed to permit an operation content in accordance with the age of a speaker in the case where an operation instruction is issued by voice.

Accordingly, it is desirable to provide a novel and improved speech recognition device and speech recognition method that are capable of receiving voice operation input in accordance with the age of a speaker.

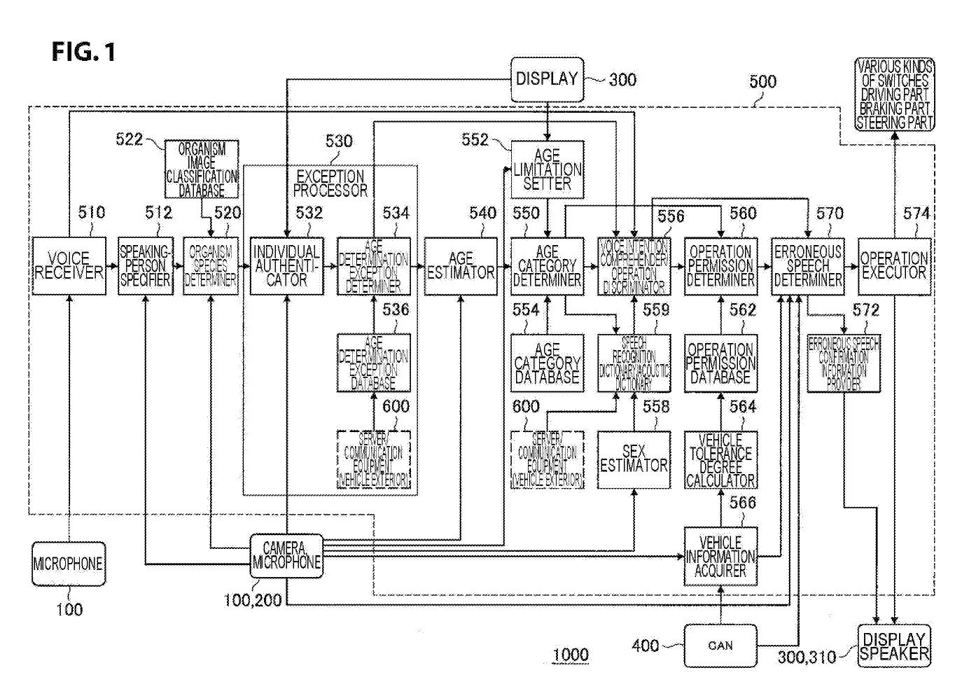

FIG. 1 is a schematic diagram illustrating a configuration of a system 1000 according to an embodiment of the disclosure. The system 1000 is installed on a vehicle such as an automobile. As illustrated in FIG. 1, the system 1000 includes a microphone 100, a camera 200, a display 300, a loudspeaker 310, a Controller Area Network (CAN) 400, and a control device (speech recognition device) 500.

The microphone 100, the camera 200, the display 300, and the loudspeaker 310 is disposed in the interior of the vehicle. The microphone 100 acquires voice in the interior of the vehicle, and mainly acquires voice of speeches of occupants. The number of the microphones 100 installed in the interior of the vehicle may be two or more. The camera 200 is implemented by a visible light camera, an infrared camera, or the like, and mainly captures images of faces of the occupants. The display 300 is disposed at a position where an occupant of the vehicle can see the display 300. The display 300 displays information and provides the occupant with the information. The loudspeaker 310 is disposed in the interior of the vehicle, and provides the occupants with information by voice or sound.

The control device 500 includes a voice receiver 510, a speaking-person specifier 512, an organism species determiner 520, an organism image classification database 522, an exception processor 530, an age estimator 540, an age category determiner 550, an age limitation setter 552, an age category database 554, a voice intention comprehender/operation discriminator 556, a sex estimator 558, a speech recognition dictionary 559, an operation permission determiner 560, an operation permission database 562, a vehicle tolerance degree calculator 564, a vehicle information acquirer 566, an erroneous speech determiner 570, an erroneous speech confirmation information provider 572, and an operation executor 574.

The exception processor 530 includes an individual authenticator 532, an age determination exception determiner 534, and an age determination exception database 536. Note that, the structural elements of the control device 500 illustrated in FIG. 1 are implemented as a circuit (hardware) or a central processing unit such as a CPU and a program (software) for causing them to function.

The system 1000 is capable of communicating with an external server 600. For instance, Bluetooth (registered trademark), Wi-Fi, 4G, or the like may be used as a communication method. Note that, the communication method is not specifically limited.

Data accumulated in databases such as the organism image classification database 522, the age category database 554, the operation permission database 562, and the age determination exception database 536 that are included in the system 1000 may be data downloaded from the external server 600 by communicating with the server 600.

Alternatively, the data accumulated in such databases may be held by the server 600 (cloud) side. In this case, the system 1000 accesses the server 600 and acquire data when using the data.

According to the embodiment of the disclosure, the system 1000 including the above-described structural elements discriminates a content of operation on the basis of a speech, and performs the operation intend by an occupant of a vehicle when the occupant speaks to operate the vehicle. At this time, the age of the speaker is estimated on the basis of information acquired by the camera 200 or the microphone 100, and the operation is permitted or prohibited (rejected) in accordance with the age of the speaker. According to the embodiment of the disclosure, it is possible to perform optimum operation corresponding to age by performing the above-described process.

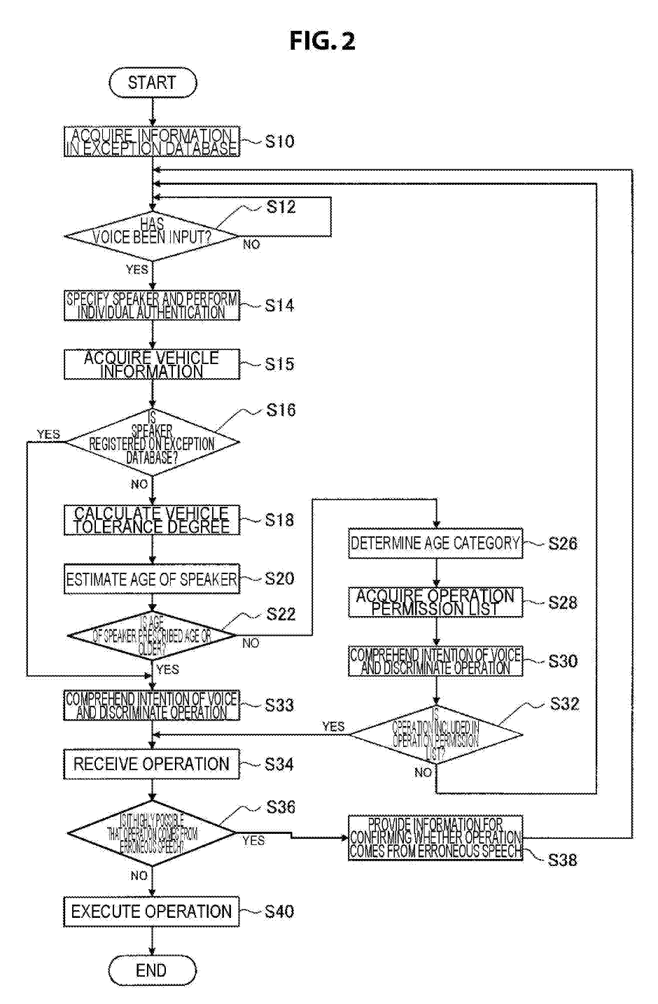

FIG. 2 is a flowchart illustrating a process performed in the control device 500. First, in the step S10, information in the age determination exception database 536 is acquired. In the next step S12, it is determined whether voice acquired by the microphone 100 is input to the voice receiver 510. The process proceeds to the step S14 in the case where the voice is input to the voice receiver 510. In the step S14, the speaking-person specifier 512 specifies a speaker, and the individual authenticator 532 performs individual authentication of the speaker. At this time, the speaking-person specifier 512 specifies that the speaker is a person closest to a microphone 100 that has received loudest voice on the basis of voice information obtained from microphones 100. In addition, the speaking-person specifier 512 is also capable of specifying that the speaker is a person with open mouth on the basis of an image of the occupants captured by the camera 200. The individual authenticator 532 performs the individual authentication of the speaker specified by the speaking-person specifier 512.

For instance, the individual authentication may use fingerprint authentication, iris authentication, face authentication, or the like. Such authentication methods use publicly known methods appropriately. For instance, a method disclosed in Japanese Patent No. 2772281 may be used as the fingerprint authentication, a method disclosed in Japanese Patent No. 3853617 may be used as the iris authentication, and a method disclosed in Japanese Unexamined Patent Application Publication No. 2002-183734 may be used as the face authentication, appropriately.

More preferably, the individual authentication is performed when the occupants ride the vehicle. In this case, in the step S14, it is possible to apply results of the individual authentication that have already been performed when they have ridden the vehicle, to the speaker specified by the speaking-person specifier 512.

In addition, the organism species determiner 520 determines whether the speaker specified by the speaking-person specifier 512 is a human, an animal, a robot, or the like other than the human on the assumption that the individual authenticator 532 performs the individual authentication. On the organism image classification database 522, image information of robots, image information of animals such as dogs, cats, and parrots that are commonly kept as pets are registered. The organism species determiner 520 determines whether the speaker specified by the speaking-person specifier 512 is a human or something other than the human on the basis of the image information registered on the organism image classification database 522. In the case where the organism species determiner 520 determines that the speaker is not a human, subsequent processes do not have to be performed.

In the next step S15, the vehicle information acquirer 566 acquires vehicle information from the CAN 400. Here, for instance, the vehicle information includes information such as vehicle speed, map information, a congestion situation around the vehicle, a field of vision around the vehicle, a steering angle of a steering wheel, weather, and information of a navigation device. The vehicle speed is obtained by a vehicle speed sensor. It is possible to acquire the congestion situation around the vehicle and the field of vision around the vehicle from images of vicinities of the vehicle captured by the camera 200. The steering angle is obtained by a steering angle sensor. The weather is obtained from weather information r acquired through communication between the vehicle and an external server or the like. Note that, the vehicle information is overall information related to driving of the vehicle, and the vehicle information is not limited to the above-described instances.

In the next step S16, the exception processor 530 performs a process as a result of the individual authentication performed in the step S14. As described above, according to the embodiment of the disclosure, voice operation is permitted or rejected in accordance with the age of a speaker. However, sometimes the age estimation process does not have to be performed on a person whose voice operation is absolutely permitted regardless of his/her age, for instance, in the case where an owner of the vehicle performs operation. The exception processor 530 performs an exception process on a specific person whose voice operation is absolutely permitted, as a result of the individual authentication. Subsequently, the voice operation performed by the specific person is permitted. In such a way, it is possible to simplify the process performed in the system 1000.

In addition, in the step S16, the age determination exception determiner 534 determines whether the speaker is registered on the age determination exception database 536 acquired in the step S10. In the age determination exception database 536, information such as a name and age of a person to be subjected to the exception process is stored in association with individual authentication information such as a fingerprint, an iris, or a face that are used for the individual authentication.

The age determination exception determiner 534 determines that the speaker is the person registered on the age determination exception database 536, in the case where the individual authentication information such as the fingerprint, iris, or face of the speaker is identical to the individual authentication information registered on the age determination exception database 536 as a result of the individual authentication. In this case, the information of the speaker is registered on the age determination exception database 536. Therefore, the exception process is applied to the speaker and the age estimator 540 does not estimate the age of the speaker. Accordingly, the process proceeds to the step S33 after the step S16. Alternatively, the process may proceed to the step S26 or a subsequent step on the basis of the age of a speaker registered on the age determination exception database 536.

On the other hand, in the case where the individual authentication fails in the step S16 or in the case where the speaker is not registered on the age determination exception database 536, the process proceeds to the step S18 and a normal process is performed instead of the exception process. In the step S18, the vehicle tolerance degree calculator 564 calculates a vehicle tolerance degree on the basis of the vehicle information acquired by the vehicle information acquirer 566. The vehicle tolerance degree is a parameter indicating a tolerance degree of the vehicle in a state in which the vehicle is being driven. For instance, the vehicle tolerance degree is set to a value between 0 and 1.0. For instance, the vehicle tolerance degree is set in accordance with vehicle speed. The vehicle tolerance degree may be 0.5 in the case where the vehicle speed is 60 km/h or more. The vehicle tolerance degree may be 0.3 in the case where the vehicle speed is 80 km/h or more. The vehicle tolerance degree may be 0 in the case where the vehicle speed is 100 km/h or more.

Alternatively, the vehicle tolerance degree is set in accordance with the congestion state around the vehicle. The vehicle tolerance degree may be 0.5 in the case where there is another vehicle within 5 meters around the vehicle. The vehicle tolerance degree may be 0.3 in the case where there is another vehicle within 3 meters around the vehicle. The vehicle tolerance degree may be 0 in the case where there is another vehicle within 1.5 meters around the vehicle.

Alternatively, the vehicle tolerance degree is set in accordance with a field of vision (visibility) around the vehicle. The vehicle tolerance degree may be 0.3 in front of a curve, and the vehicle tolerance degree may be 0.1 in the case where the vehicle is traveling on a narrow road. Alternatively, the vehicle tolerance degree is set in accordance with a steering angle of the steering wheel. The vehicle tolerance degree may be 0.7 in the case where the steering angle is 10° or more. The vehicle tolerance degree may be 0 in the case where the steering angle is 90° or more. Alternatively, the vehicle tolerance degree is set in accordance with weather. The vehicle tolerance degree may be 0.8in the case of a light rain. The vehicle tolerance degree may be 0.1 in the case of a heavy rain. The vehicle tolerance degree may be 0 in the case of a snowstorm.

It is also possible to calculate the vehicle tolerance degree by multiplying a value corresponding to the vehicle speed, congestion state, field of vision, steering angel, or weather described above. Tolerance for a vehicle driving state decreases as the value of the vehicle tolerance degree gets lower. At this time, sometimes the driving may be interfered with when disturbance occurs.

After the step S18, the process proceeds to the step S20. In the step S20, the age estimator 540 estimates the age of the speaker. The age estimator 540 estimates the age of the speaker on the basis of a feature quantity of a face, a feature quantity of voice, a feature quantity of breathing, a result of behavior analysis or preference analysis, or the like of the speaker. Note that, a method disclosed in Japanese Patent No. 5827225 may be used for age estimation based on a feature quantity of a face, for instance. In addition, a method disclosed in Japanese Patent No. 5637583 may be used for age estimation based on a feature quantity of breathing, for instance.

After the step S20, the process proceeds to the step S22. In the step S22, it is determined whether the age of the speaker is a prescribed age or older. In the case where the age of the speaker is the prescribed age or older, the speaker is adult sufficiently. Therefore, it is not necessary to limit his/her voice operation. Accordingly, in the case where the age of the speaker is the prescribed age or older, the process proceeds to the step S33, and proceeds to the subsequent process without limiting the operation because of his/her age. The prescribed age in the step S22 is set by the age limitation setter 552. For instance, when the prescribed age is set to 50 years old, the operation is not limited because of his/her age in the case where the speaker is 50 years old or older.

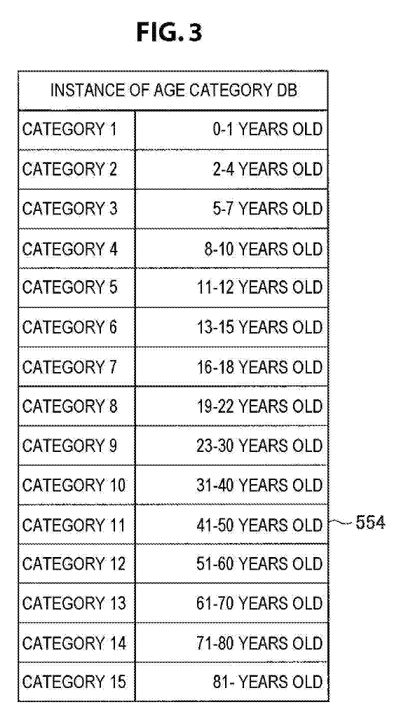

On the other hand, the process proceeds to the step S26 in the case where it is determined that the age of the speaker is less than the prescribed age in the step S22. In the step S26, the age category determiner 550 refers to the age category database 554 and determines a category of the age on the basis of a result of the age estimation performed in the step S20. FIG. 3 is a schematic diagram illustrating an instance of the age category database 554. The age category determiner 550 refers to the age category database 554 illustrated in FIG. 3. For instance, the age category 9 is selected in the case where a result of the age estimation indicates 23 to 30 years old. Note that, the age category segments illustrated in FIG. 3 are a mere instance. It is possible to classify age into any category.

After the step S26, the process proceeds to the step S28. In the step S28, the operation permission determiner 560 acquires data stored in the operation permission database 562. In the next step S30, the voice intention comprehender/operation discriminator 556 comprehends an intention of voice input to the voice receiver 510, and discriminates a content of the operation intended by the voice.

The speech recognition dictionary (acoustic dictionary) 559 is used when the voice intention comprehender/operation discriminator 556 comprehends an intention of the voice. The speech recognition dictionary (acoustic dictionary) 559 holds data (voice data) of words and meanings of the words in association with each other. The speech recognition dictionaries 559 are created in accordance with human age groups. For instance, a dictionary for an age group of 20 s is created by applying machine learning to speech data of people in their 20 s, and a dictionary for an age group of 40 s is created by applying machine learning to speech data of people in their 40 s. In the case where the age estimator 540 estimates that the speaker is in his/her 20 s, the dictionary for the age group of 20 s is used for comprehending an intention of the voice of the speaker.

In addition, the sex estimator 558 estimates sex of the speaker, and changes a parameter for using the speech recognition dictionary 559 in accordance with whether the speaker is male or female. For instance, the above-described dictionary for the age group of 20 s includes a male dictionary and a female dictionary. In the case where the speaker is estimated to be in his/her 20 s, the dictionary to be used for comprehending voice is changed in accordance with whether the speaker is male or female. Accordingly, it is possible to comprehend the intention of the voice in view of sexual difference when comprehending the intention of the voice. Therefore, it is possible to comprehend the intention of the voice more accurately and it is possible to discriminate the operation with high accuracy on the basis of the intention of the voice. The sex estimator 558 determines the sex on the basis of a feature quantity of an image of a face captured by the camera 200, a feature quantity of voice acquired by the microphone 100, muscle mass of an occupant estimated from an image captured by the camera 200, a result of analyzing behavior or preference of an occupant, or the like.

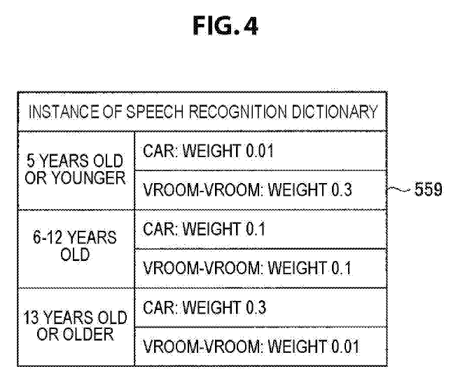

FIG. 4 is a schematic diagram illustrating an instance of the speech recognition dictionary 559. As illustrated in FIG. 4, weight coefficients of words “car” and “vroom-vroom” spoken by the speaker are changed in accordance with his/her age when recognizing the word “car” representing an automobile. Note that, the word “vroom-vroom” is baby talk representing a “car”, and this is wording especially used in his/her childhood. The weight coefficient is a fitting coefficient when converting voice into words. A word with a larger weight coefficient is easily adopted when comprehending an intention of the voice. More specifically, it is also possible to collect speech sentence data obtained during normal conversations among peoples in each age group, and decide word coefficients of respective words on the basis of frequency of use of the words during the normal conversations. In this case, it is also possible to communicate with the external server 600 and update the dictionary to a dictionary that also takes trends into consideration.

The voice intention comprehender/operation discriminator 556 comprehends an intention of voice in accordance with the following processes 1 to 6, for instance:
1. Cut out a waveform of input voice into phonemes;
2. Extract feature quantities of the phonemes;
3. Compare the feature quantities of the phonemes with phoneme models (acoustic dictionary) and fix the phonemes;
4. Generate sets of characters from sets of phonemes;
5. Fit the sets of the characters into a word dictionary and language models and generate a sentence; and
6. Estimate an intention of the characters on the basis of vicinity information.

It is possible to comprehend an intention of the sentence from the voice, by fitting the sentence obtained through speech recognition into the speech recognition dictionary (acoustic dictionary) 559. As the above-described method, it is possible to appropriately use a publicly known method such as a method disclosed in Japanese Examined Patent Publication No. S60-5960.

Next, the voice intention comprehender/operation discriminator 556 discriminates a content of the operation on the basis of the intention of the vice acquired through the above-described method. For instance, the voice intention comprehender/operation discriminator 556 is capable of discriminating the content of the operation with reference to data in which intentions of voice are associated with contents of operation. In the next step S32, the operation permission determiner 560 determines whether the operation permission database 562 includes the operation discriminated by the voice intention comprehender/operation discriminator 556, with reference to contents of the operation permission database 562.

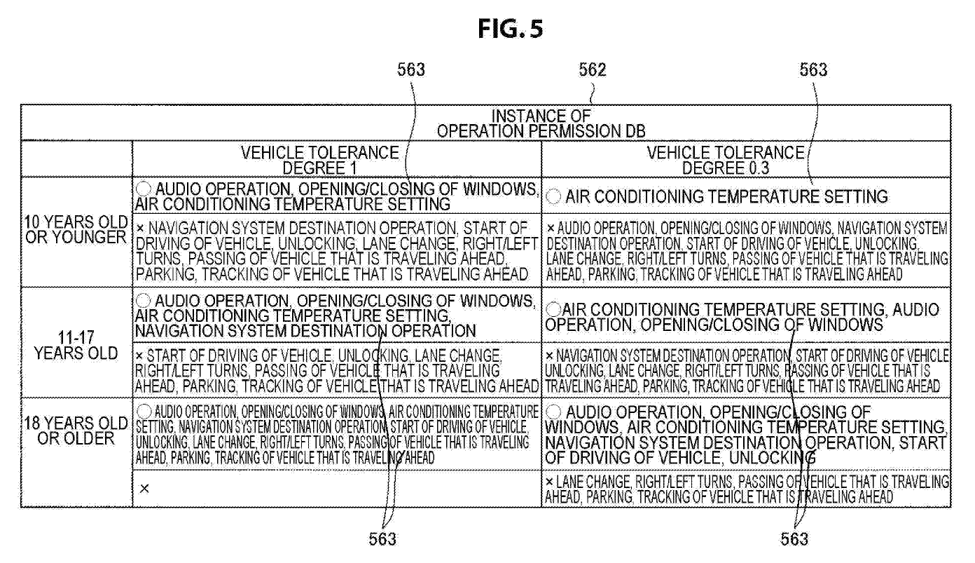

FIG. 5 is a schematic diagram illustrating data stored in the operation permission database 562. As illustrated in FIG. 5, the operation permission database 562 stores a list of permitted operations (operation permission list 536) according to age categories and vehicle tolerance degrees. In FIG. 5, permitted operations are denoted by a sign of ∘, and rejected operations are denoted by a sign of ×. As illustrated in FIG. 5, for instance, in the case where the age category represents 11 to 17 years old and the vehicle tolerance degree is 0.3, operation instructions related to air conditioning temperature setting, audio operation, or opening/closing of windows are permitted, but operation instructions related to a destination of a navigation system, start of driving of the vehicle, unlocking, lane change, right/left turns, passing of a vehicle that is traveling ahead, parking, and tracking of a vehicle that is traveling ahead are rejected. As described above, permission and prohibition of operation are stipulated in accordance with age and a vehicle tolerance degree. Therefore, it is possible to permit only optimum operation in accordance with the age of a person who performs the operation and a current tolerance degree of a vehicle. For instance, operation that is not appropriate for that age is prohibited. In addition, operation is also prohibited in the case where the current tolerance degree of the vehicle is insufficient for executing the operation.

In the step S32, the process proceeds to the step S34 in the case where the operation discriminated by the voice intention comprehender/operation discriminator 556 is included in the operation permission list corresponding to the age category decided in the step S26 and the vehicle tolerance degree calculated in the step S18. On the other hand, the process returns to the step S12 in the case where the operation discriminated by the voice intention comprehender/operation discriminator 556 is not included in the operation permission list corresponding to the age category and the vehicle tolerance degree. Note that, the operation permission determiner 560 may determine permission/prohibition of operation on the basis of only one of the age category and the vehicle tolerance degree.

Alternatively, as described above, the process proceeds to the step S33 in the case where the speaker is registered on the age determination exception database 536 in the step S16. In this case, the age estimator 540 does not estimate the age of the speaker and it is not determined whether the operation is permitted or prohibited on the basis of the operation permission database 562. In the step S33, the voice intention comprehender/operation discriminator 556 comprehends a meaning of the voice that is input to the voice receiver 510, and discriminates a content of the operation intended by the voice. The process in the step S33 is performed in a way similar to the step S30. After the step S33, the process proceeds to the step S34.

In the step S34, a process of receiving voice operation is performed. In the next step S36, the erroneous speech determiner 570 determines whether the voice operation received in the step S34 is possibly an erroneous speech. It is determined whether the voice operation is possibly an erroneous speech on the basis of vehicle information. For instance, it is determined that the voice operation is possibly an erroneous speech in the case of receiving an operation instruction like “an instruction to move forward although a shop is in front of the vehicle in the case of starting driving the vehicle in a parking lot of the shop”, “an instruction to open a window although it is raining heavily”, or “an instruction to set a destination to his/her office although today is a holiday”.

Next, the process proceeds to the step S38 in the case where the voice operation is possibly an erroneous speech. In the step S38, the erroneous speech confirmation information provider 572 shows information for confirming whether the voice operation is an erroneous speech, on the display 300. For instance, in the step S38, information such as “I cannot hear your operation instruction by my microphone. Please instruct me again.” is provided as the information for confirming whether the voice operation is an erroneous speech.

In addition, the process proceeds to the step S40 in the case where there is no possibility that the voice operation is an erroneous speech in the step S36. In the step S40, the operation executor 574 executes operation corresponding to the voice operation instruction that has been input. For instance, the operation executed in the step S40 may be operation to flip various kinds of switches, to drive, brake, or steer the vehicle, to switch voltage, to switch frequency, to open/close a window of the vehicle, to set a destination of the car navigation system, or the like.

As described above, according to the embodiment of the disclosure, it is possible to determine permission/prohibition of operation in accordance with the age of a speaker. Therefore, it is possible to appropriately receive operation in accordance with the age. In addition, it is also possible to determine permission/prohibition of operation on the basis of age and a vehicle tolerance degree. Therefore, it is also possible to receive operation in accordance with the age and the vehicle tolerance degree.

Although the embodiments of the disclosure have been described in detail with reference to the appended drawings, the disclosure is not limited thereto. It is obvious to those skilled in the art that various modifications or variations are possible insofar as they are within the technical scope of the appended claims or the equivalents thereof. It should be understood that such modifications or variations are also within the technical scope of the disclosure.

1. A speech recognition device comprising:
a voice receiver configured to receive a speech voice of a speaker;
an age estimator configured to estimate an age of the speaker;
an operation discriminator configured to discriminate an operation intended by the speaker on a basis of the speech voice; and
an operation permission determiner configured to determine a permission or a prohibition of the operation on a basis of the estimated age of the speaker.

2. The speech recognition device according to claim 1, further comprising:
an age category database that includes at least two age categories into which the age of the speaker is to be classified; and
an age category determiner configured to classify the estimated age of the speaker into an age category of the at least two age categories in the age category database,
wherein the operation permission determiner determines the permission or the prohibition of the operation on a basis of the age category.

3. The speech recognition device according to claim 1, further comprising:
a vehicle information acquirer configured to acquire a vehicle information;
a vehicle tolerance degree calculator configured to calculate a vehicle tolerance degree from the vehicle information;
an operation permission database that defines a relation between the age category of the speaker, the vehicle tolerance degree, and the permission or the prohibition of the operation; and
an operation permission determiner configured to determine whether the operation intended by the speaker is included in an operation list in the operation permission database, the operation having been discriminated on the basis of the speech voice, the operation list having been defined by the age category of the speaker and the vehicle tolerance degree,
wherein the operation permission determiner determines to permit the operation in a case where the operation list includes the operation intended by the speaker, the operation having been discriminated on the basis of the speech voice.

4. The speech recognition device according to claim 3,
wherein the operation permission database is a database that classifies the age into one of the at least two categories, classifies the vehicle tolerance degree into one of the at least two categories, and defines an operation list depending on the age category and the category of the vehicle tolerance degree.

5. The speech recognition device according to claim 1, further comprising
a speaking-person specifier configured to specify the speaker among occupants of a vehicle.

6. The speech recognition device according to claim 1, further comprising
a determiner configured to determine whether the speaker is something other than a human on a basis of a captured image of the speaker,
wherein the operation is prohibited when the speaker is something other than a human.

7. The speech recognition device according to claim 1, further comprising
an individual authenticator configured to perform an individual authentication of the speaker,
wherein, in a case where the individual authentication succeeds, the operation permission determiner permits the operation regardless of the age of the speaker.

8. The speech recognition device according to claim 1, further comprising:
an age determination exception database on which a specific person is registered as an exception to an age determination; and
an exception determiner configured to determine that the speaker registered on the age determination exception database is an exception,
wherein the operation permission determiner permits the operation to the speaker who is determined to be the exception, regardless of the age.

9. The speech recognition device according to claim 8,
wherein the age determination exception database is updated through a communication with an external server.

10. The speech recognition device according to claim 2, further comprising
a speech recognition dictionary in which a weight of a registered word is variable in accordance with the age categories,
wherein the operation discriminator comprehends an intention of the speaker on a basis of the speech recognition dictionary.

11. The speech recognition device according to claim 4, further comprising
a speech recognition dictionary in which a weight of a registered word is variable in accordance with the age categories,
wherein the operation discriminator comprehends an intention of the speaker on a basis of the speech recognition dictionary.

12. The speech recognition device according to claim 10,
wherein the speech recognition dictionary is updated through communication with an external server.

13. The speech recognition device according to claim 1, further comprising
an operation executor configured to execute the operation that the operation permission determiner has determined to permit.

14. The speech recognition device according to claim 12, further comprising
an erroneous speech determiner configured to determine an erroneous speech of the speaker on a basis of a vehicle information of a vehicle in which the speaker is riding,
wherein the operation executer does not execute the operation in a case where it is determined that a speech of the speaker is the erroneous speech.

15. A speech recognition method comprising:
receiving a speech voice of a speaker;
estimating an age of the speaker;
discriminating an operation intended by the speaker on a basis of the speech voice; and
determining a permission or a prohibition of the operation on a basis of the estimated age of the speaker.

16. A speech recognition device comprising:
circuitry configured to
receive a speech voice of a speaker,
estimate an age of the speaker,
discriminate an operation intended by the speaker on a basis of the speech voice, and
determine a permission or a prohibition of the operation on a basis of the estimated age of the speaker.
